(19) United States
(12) Patent Application Publication
(10) Pub. No.: US 2017/0057801 A1
(43) Pub. Date: Mar. 2, 2017

(54) METHOD AND FILLING SYSTEM FOR FILLING CONTAINERS

(71) Applicant: KHS GmbH, Dortmund (DE)

(72) Inventors: Ludwig Clusserath, Bad Kreuznach (DE); Dieter-Rudolf Krulitsch, Bad Kreuznach (DE)

(21) Appl. No.: 15/118,525

(22) PCT Filed: Feb. 5, 2015
(86) PCT No.: PCT/EP2015/052354

§ 371 Date: Aug. 12, 2016

(30) Foreign Application Priority Data
Feb. 12, 2014 (DE) 10 2014 101 708.0

(51) Int. Cl. B67C 3/26; B67C 3/04

(52) U.S. Cl. CPC B67C 3/2634; B67C 3/262; B67C 3/04; B67C 2003/2668

(57) ABSTRACT

A method for filling a container with spirit or wine includes using a valve to control flow of filling material into a container sealed against a plant from. Once the container has been filled, and while the valve is closed, pressurized Trinox gas drives surplus fluid out of the container. A Trinox gas path through which the gas flows passes through a bellows and opens into a head space of the container.

### RELATED APPLICATIONS

This application is the national stage, under 35 USC 371, of PCT application PCT/EP2015/052354, filed on Feb. 5, 2015, which claims the benefit of the Feb. 12, 2014 priority date of German application DE 10 2014 101 708.0, the content of which is herein incorporated by reference.

### FIELD OF INVENTION

The invention is directed to processing containers, and in particular, to filling machines.

### BACKGROUND

In filling a container, it is important to be able to control the filling level in the container. A variety of known ways exist for controlling the filling level.

A number of ways exist to control filling level. Among these are methods that rely on a tube inserted into the container. In some methods, liquid enters and displaces gas out of this tube. This proceeds until the tube becomes submerged, at which point the gas can no longer be displaced since it is has no way to get into the tube. The resulting rise in gas pressure halts the incoming flow.

Another method, often called the “Trinox method,” involves filling the container until this tube is slightly submerged, and then allowing a pressurized gas to enter the head space of the container. This pressurized gas pushes surplus liquid out of the container through the tube. This lowers the fill level until eventually the tube's lower end emerges out of the liquid. At this point, the gas displaces no further liquid.

### SUMMARY

An object of the invention is that of filling containers with spirits and/or wine to an exact filling level while also complying with the demands, requirements, and general hygiene conditions of companies that bottle spirits.

A filling system according to the invention is particularly suitable for bottling spirits and/or wine and meets the requirements and demands placed on filling systems of this type in an optimum manner.

In one aspect, the invention features a computer-controlled filling system, i.e. one in which there is no mechanical opening of the liquid valves of the filling positions. The filling system guarantees a hygienic design since no sliding seals are required between a hygiene area and the environment. The container mouth is not wetted with the filling material while the containers are being filled. Instead the filling material flow, i.e. the discharge of filling material from the filling element of the respective filling position, takes place inside the container beneath the container mouth, i.e. roughly level with the desired filling level. The inventive filling system facilitates precise setting of the filling level by way of the Trinox method.

In another aspect, the invention features a method for correcting filling level. According to this method, the head space of the respective container is filled with a Trinox gas from a Trinox duct that is provided on the machine element for all filling positions in common, and through a Trinox gas path that is preferably provided separately for each filling position. At least part of the length of the Trinox gas path is configured inside a bellows that extends between a plant and a filling element housing of the respective filling element and/or machine element and/or a rotor. This makes for an operationally reliable and easy-to-construct simplified configuration of the Trinox gas path while allowing the plant to be adjusted in height relative to the filling elements, e.g., for the purpose of adjusting the filling level. In a preferred embodiment, the filling elements each comprise a filling tube. The Trinox gas path is then configured as an annular channel between the bellows that surrounds the filling tube.

In another embodiment, the filling material that is entrained by return gas during filling and/or that is displaced out of the container by the Trinox gas used during filling level correction enters a separate collection-and-separation chamber and does not return to the filling-material tank, thereby reliably avoiding the risk of contamination of filling material in the filling-material tank. The filling material returned to the collection-and-separation chamber, where it is also separated from gaseous constituents, is either discarded or preferably is returned to the filling system after appropriate treatment thereof.

For the purpose of the invention the expression “container located in sealed position with the filling element” means that the container to be filled is arranged with its container mouth sealed on the filling position or is pressed tightly up against a seal surrounding the filling tube of the filling element.

For the purpose of the invention the expressions “substantially” or “around” mean variations from the respective exact value by ±10%, preferably by ±5% and/or variations in the form of changes insignificant for the function.

Further embodiments, advantages, and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

### BRIEF DESCRIPTION OF THE DRAWINGS

The invention is explained in detail below through the use of exemplary embodiments with reference to the figures, in which:

FIG. 1 shows a simplified sectional view through a filling position of a filling system for filling containers with a liquid filling material;

FIG. 2 shows a detail of the filling system of FIG. 1 in section and in an enlarged partial representation;

FIG. 3 shows a simplified schematic view of the filling position of a vacuum filling system for filling containers with a liquid filling material;

FIG. 4 shows a simplified sectional view of the upper end of a return-gas tube of the filling system of FIG. 3 together with the collection-and-separation channel and a pneumatically operated valve; and

FIG. 5 shows a view similar to that shown in FIG. 4 with a further embodiment of the invention.

### DETAILED DESCRIPTION

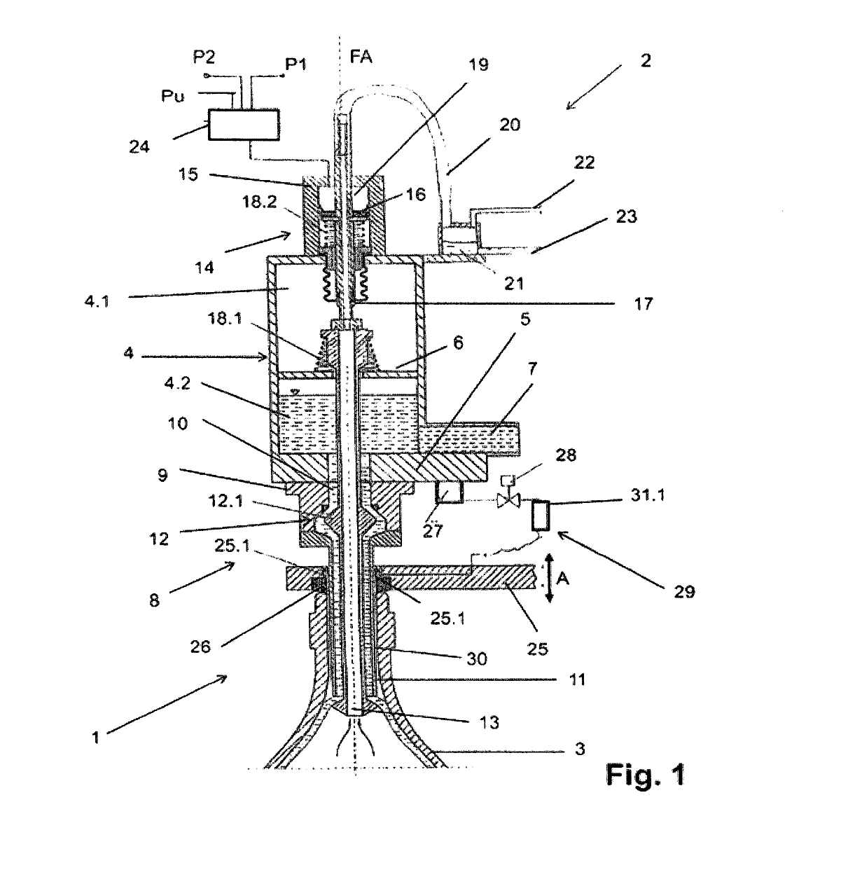

FIG. 1 shows a filling position 1 of a filling system 2 of a rotary filling machine for the filling liquid filling material into containers 3. The illustrated filling machine is configured to have structure that permits it to carry out filling without pressurization. This will be referred to herein as “pressureless” filling. In the illustrated embodiment, the containers 3 are bottles.

The filling system 2 includes an annular filling-material tank 4 that is disposed about the periphery of a rotor 5. The rotor 5 rotates about a vertical machine-axis that is concentric with the rotor's center. A partition 6 divides the filling-material tank's interior into an upper chamber 4.1, which holds gas, and a lower chamber 4.2, which holds filling material.

During filling, a supply connector 7 provides liquid filling-material that partially fills the lower chamber 4.2. Each filling position 1 has a filling element 8 having a filling element housing 9 that is provided on the rotor beneath the filling-material tank 4.

A liquid channel 10 in the housing 9 has an upper end that opens out into the lower chamber 4.2. At the bottom end of the housing 9, the liquid channel 10 merges into an annular channel of a filling tube 11. At its open bottom end, the filling tube 11 forms a discharge opening through which the liquid filling material flows to the interior of a container 3 during filling thereof.

Inside the liquid channel 10 a liquid valve 12 has a valve body 12.1 that interacts with a valve seat in the liquid channel 10. The valve body 12.1 is on a return-gas tube 13 that is co-axial with a vertical filling-element axis FA. The return-gas tube 13 thus acts as a valve stem that opens and closes the liquid valve 12. In particular, a predetermined opening and closing stroke moves the return-gas tube 13 along the filling-element axis FA to open and close the liquid valve 12.

In the illustrated embodiment, a first compression-spring 18.1 pre-tensions the return-gas tube 13, and hence the valve body 12.1, for upward movement. This biases the liquid valve 12 into its closed position. As shown in the figure, the first compression-spring 18.1 is in the upper chamber 4.1.

A pneumatic actuator 14 at the top of filling-material tank 4 includes a cylinder 15, a piston 16 with plunger or piston rod 17, and a second compression-spring 18.2 that is used to open liquid valve 12. Above the piston 16, a control chamber 19 whose spring force is less than the spring force of the first compression-spring 18.1 is formed in the cylinder 15.

The second compression-spring 18.2, which pre-tensions the piston 16 upwards, is beneath the piston 16. A section of tube forms the piston in 17 that is coaxial with the filling-element axis FA. The piston rod 17 thus has a channel that is open at both ends. In its operating position, as shown in the figure, a ring seal at the bottom end of the piston rod 17 rests against the upper open end of the return-gas tube 13 in the upper chamber 4.1. This connects the channels of the piston rod 17 and return-gas tube 13 to form one long channel.

At its upper end, the piston rod 17 exits the control chamber 19 through a seal and connects to a flexible connecting-line 20. The connecting-line 20 than enters an interior space of a separation-and-collection chamber 21 through a top face thereof.

The separation-and-collection chamber 21 is an annular chamber disposed on top of the tank 4 so that it can serve all the filling positions 1 of the filling machine at the same time. The chamber's interior connects to a first connector 22 and a second connector 23. The first connector 22 removes gas, including return gas, and the second connector 23 removes filling material.

An electrically operated control valve 24 operates actuation element 14. The control valve 24 has first, second, and third settings.

The first setting applies a first control pressure PI to the control chamber 19. The resulting force exceeds the sum of the spring forces of the first and second compression-springs 18.1, 18.2. As a result, the liquid valve 12 opens.

The second setting applies, to the control chamber 19, a second control pressure P2 for closing liquid valve 12. This second control pressure P2 produces a force that that is greater than the spring force of the second compression-spring 18.2 but less than the spring force of the first compression-spring 18.1.

The third setting applies, to the control chamber 19, the ambient pressure Pu. This breaks the connection between the return-gas tube 13 and the piston rod 17. The third setting is useful for venting the control chamber 19 as well as for CIP cleaning and/or CIP disinfection of the filling system. 2.

A plant 25 is provided in common for all filling positions 1 of the filling system. In the illustrated embodiment, the plant 25 is a ring that concentrically surrounds the vertical machine-axis. The filling tubes 11 of all the filling elements 8 pass through the plant 25. In doing so, each filling tube 11 passes through a seal 25.1. Each filling tube 11 projects beyond an underside of the plant 25 by a lower length.

The plant 25 also includes ring seals 26 that enclose the filling tubes 11. When a container 3 is being filled at a filling position 1, it stands with its mouth sealed against the ring seal 26 at that filling position 1. That filling position's filling tube 11 then reaches into its interior.

The filling system includes a distribution subsystem for controlling flow of pressurized inert gas that ultimately forces surplus filling material out of slightly overfilled containers. Consistent with usage in the art, the adjective “Trinox” will be used in connection with components of this distribution subsystem.

The distribution subsystem features an annular Trinox duct 27, a plurality of Trinox valves 28, each associated with a corresponding filling element 1, and a plurality of Trinox gas paths 29, each associated with a corresponding filling element 1.

The Trinox duct 27 connects to each filling position 1 via that filling position's associated Trinox valve 28 and its Trinox gas path 29, which is connected to the Trinox duct 27. At least part of the Trinox as path 29 is formed inside a flexible connection. In the illustrated embodiment, the flexible connection includes bellows 30.1 that extend between the rotor 5 and the plant 25.

The Trinox gas path 29 continues into the plant 25 and eventually opens through an annular gap 30 that surrounds its corresponding filling tube 11. The seal 25.1 seals this annular gap 30. The Trinox gas path 29 then extends into the interior of the container 3, which is in sealed position at the: filling element 8 or at the plant 25.

The filling system 2 is used for the pressureless filling of containers 3. This process includes raising a container 3 along the filling-element axis FA until it lies with its mouth's edge sealed against a corresponding ring seal 26. The liquid valve 12 then opens upon application of the first control pressure P1 at the control chamber 19. Beneath the container mouth, the filling material flows at normal pressure over the container's inner surface and into the container 3 at a filling rate that depends on a height difference between the height of the filling material surface in the filling-material tank 4 and the height of the discharge opening at the bottom of the filling tube 11.

As filling material flows into the bottle 2, it displaces whatever gas is already present in the container's interior. This gas, referred to as “return gas,” flows through the return-gas tube 13, through the piston rod's channel, through the connecting line 20, and finally, into the collection-and-separation chamber 21. This return gas, at least initially, does not contact the filling material in the lower chamber 4.2.

The flow of filling material into the container 3 stops automatically as soon as the rising filling material submerges the bottom end of the return-gas tube 13, which projects beyond the bottom of filling tube 11. At this point, a timer closes the liquid valve 12. In particular, the second control pressure P2 is applied to the control chamber 19.

In order to set an exact filling level or to correct the filling level, the Trinox valve 28 opens. This admits Trinox gas into the container's head space via the Trinox duct 27. This Trinox gas is at a relatively low pressure, for example between 0.5 and 1.0 bar. Suitable choices for a Trinox gas include CO2 gas and/or nitrogen).

This Trinox as forces the filling material through return-gas tube 13, the channel of the piston rod 17 and the connecting line 20 and into the collection-and-separation chamber 21. As it does so, the filling level drops. Eventually, the return-gas tube 13 will again be above the surface of the filling material in the container 3. The extent to which the return-gas tube 13 extends into the container 3 thus determines the height of the filling level in the container 3. To set this filling level, one simply adjusts the plant 25 by moving it along an adjustment direction A. Closing the Trinox valve 28 completes the filling process. At this point, the now correctly-filled container 3 can be lowered.

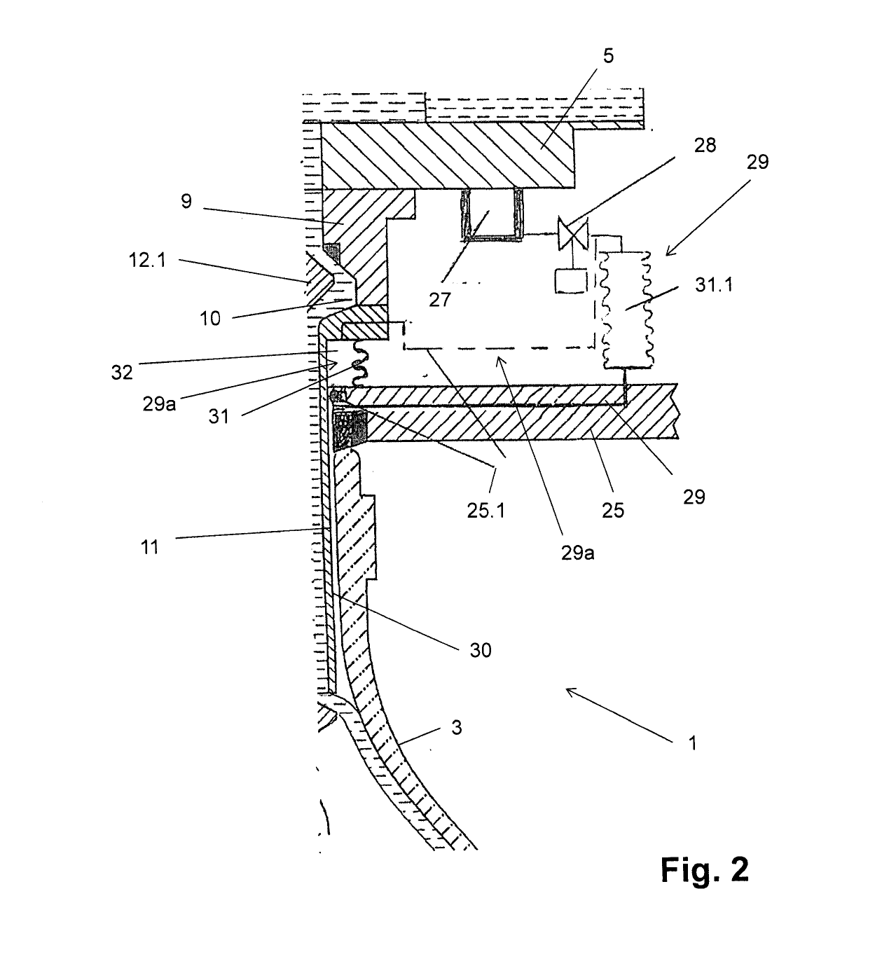

FIG. 2 shows a further embodiment of a Trinox gas path 29a, part of whose length is formed by a bellows 31 between the bottom of the filling element housing 9 and the top of the plant 25. The bellows 31 surrounds the filling tube 11. This forms an annular chamber 32 between the bellows 31 and the filling tube 11. The annular chamber 32 is sealed from the exterior and forms part of Trinox gas path 29a. An annular channel 30 connects the annular chamber 32 to the container's interior and also connects to the Trinox valve 28 via the Trinox duct 27. In this embodiment, there is no need for the seal 25.1.

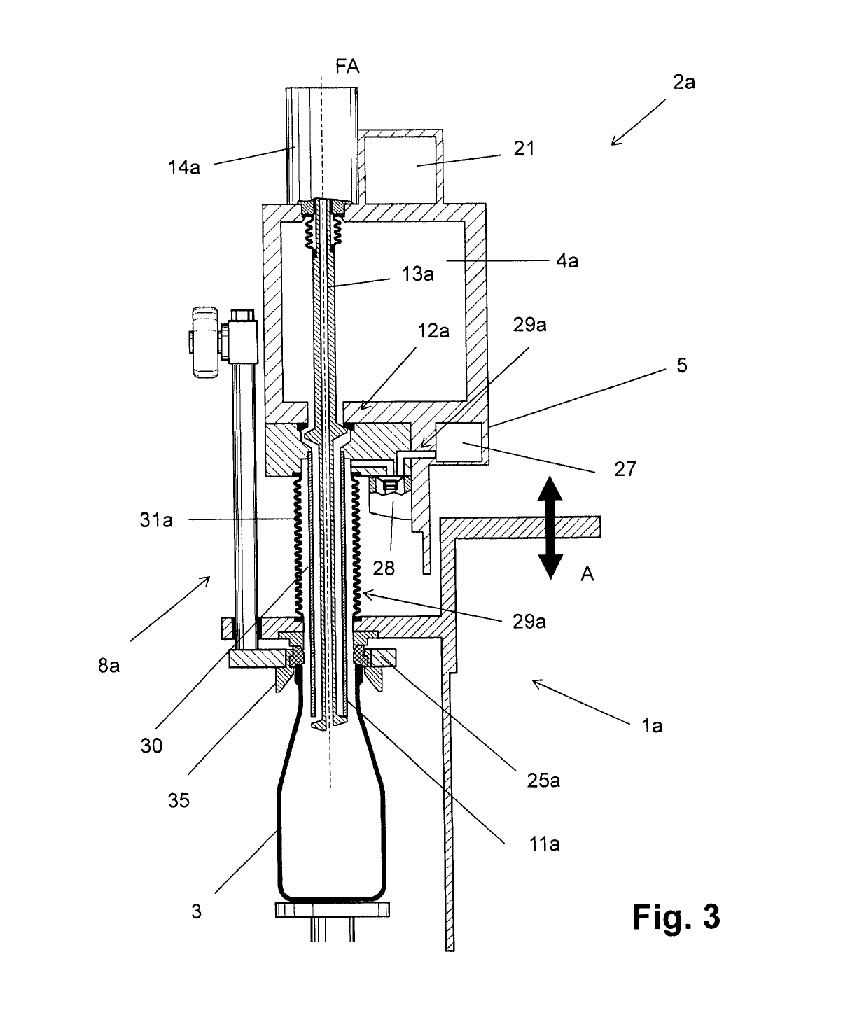

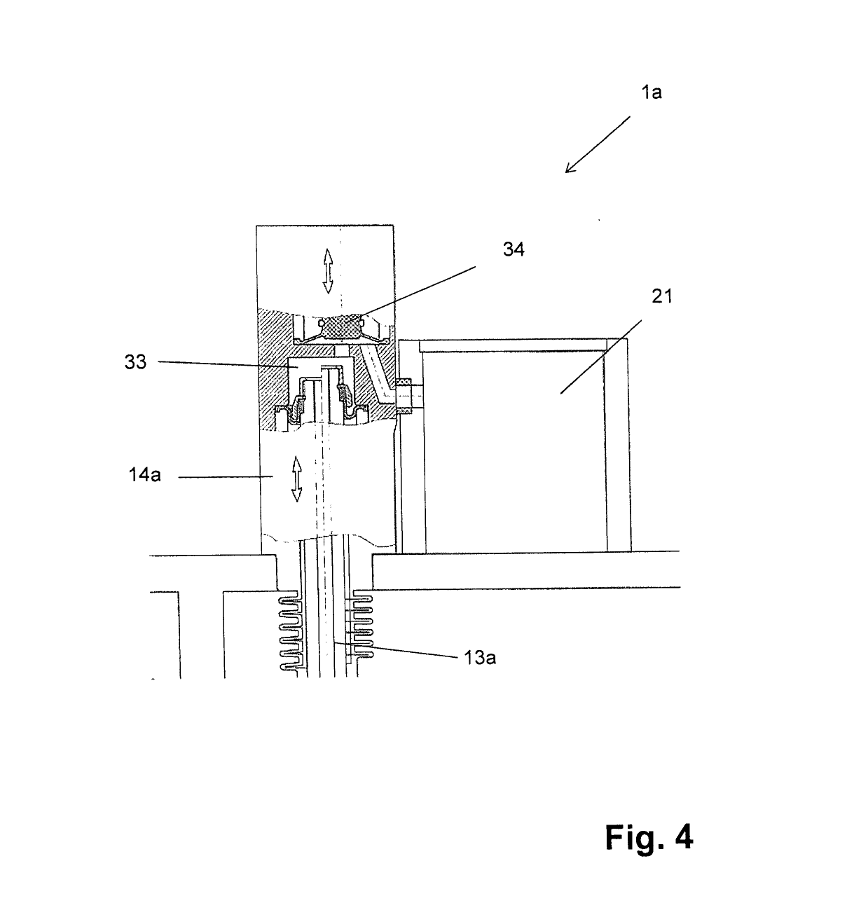

FIGS. 3 and 4 show a filling position 1a of a filling system 2a of a rotary filling machine in which a filling-material tank 4a forms part. of a rotor 5a that rotates about a vertical machine-axis. The filling-material tank 4a has a single chamber that is partly filled with liquid filling-material. In this embodiment, each filling position 1a is again associated with a filling element 8a that is provided at the bottom of filling-material tank 4a and that has a filling tube 11a that, during the filling of a container 3, extends through the container's mouth and into the container's interior. A bottom end of this filling tube 11a forms a discharge opening for the filling material.

Each filling element 8a also comprises a return-gas tube 13a that is arranged co-axially with a filling-element axis FA and that acts as a valve stem for a valve body of liquid valve 12a. This return-gas tube 13a extends through a chamber 4a.1 and exits from the top of filling-material tank 4a through a seal. At that point, the return-gas tube 13a interacts with a pneumatically-controlled actuation element 14a that opens and closes the liquid valve 12a in a controlled manner. A spring, which closes liquid valve 12a and which corresponds to the first compression-spring 18.1, is outside the filling-material tank 4a.

Referring now to FIG. 4, above the actuation element 14a, the return gas channel opens out into a filling-element chamber 33 that is individually provided for each filling position 1a. A pneumatically-operated valve 34 connects the filling-element chamber 33 to a collection-and-separation chamber 21 that is common to all of the filling positions 1a.

Referring bark to FIG. 3, the filling system 2a comprises a height-adjustable plant 25a having a plurality of centering tulips 35, each of which is associated with a filling position 1a. During filling, a container 3 at a filling position 1a lies with its opening sealed against the centering tulip 35 associated with that filling position 1a.

Each filling position la includes a bellows 31a that forms an annular channel 30 bounded in part by the filling element 11a. This annular channel 30 is part of a Trinox gas path 29a that opens into the container's interior when the container 3 lies sealed against the filling position 1a during filling. A Trinox valve 28 controls Trinox gas flow between the Trinox duct 27 and the container 3.

The filling system 2a is also suitable for vacuum filling of containers 3. In the illustrated embodiment, the second connector 23 connects the collection-and-separation chamber 21 to a vacuum source. With this being the case, opening the pneumatically-operated valve 34 communicates this vacuum to the container's interior via the channel of the return-gas tube 13a. The first connector 22 then removes liquid filling-material from the collection-and-separation chamber 21. This is container evacuation occurs before opening the liquid valve 12a. As a result, once the liquid valve 12a opens, a vacuum has been created in the container 3 that lies sealed against the filling position 1a.

After the liquid valve 12a opens, the liquid filling material flows into the container's interior through the filling tube 11a that extends into container 3. The pneumatically-operated valve 34 is closed during this operation. The flow of filling material stops once the bottom end of return-gas tube 13a is sufficiently immersed below the surface of the filling material. When this happens, the liquid valve 12a closes.

In order to set an exact filling level or to correct the filling level, Trinox gas is fed under pressure from the Trinox duct 27 into the head space of the container 3. Once the pneumatically-operated valve 34 opens, the Trinox gas displaces any surplus filling material through the return-gas tube 13a and into the collection-and-separation chamber 21. It does so until the bottom end of return-gas tube 13a is above the surface of the filling material in the container's interior. The filling level in the containers 3 can be adjusted by adjusting the height of the plant 25a.

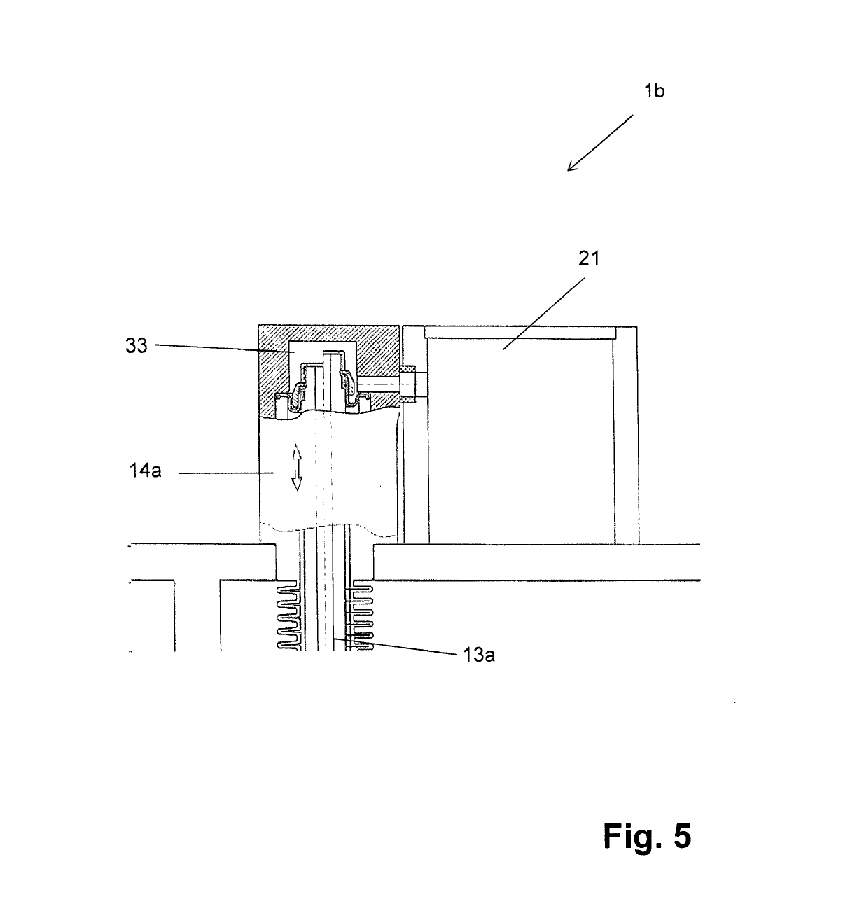

FIG. 5 shows a representation, similar to that of FIG. 4, of a filling position 1b of a filling system 2b which only differs from filling system 2a in that filling positions 1b do not have a pneumatically-operated valve 34. Instead, filling-element chamber 33 is continuously connected to the collection-and-separation chamber 21.

What all described embodiments have in common is that at least part of the Trinox gas path 29, 29a is configured inside a bellows 31, 31.1, 31A that extends between the plant 25, 25a and either the filling element housing 9, 9a or the rotor 5, and that the return gas and filling material entrained out of respective container 3 with the return gas, and in particular with the Trinox gas, is not returned to the filling-material tank 4. This avoids the risk of the filling material present in the filling-material tank 4, 4a from comingling with the entrained filling material, thus reducing contamination of the filling material in the tank 4, 4a by filling material that has already been in and out of a container 3.

The filling material that has been separated or isolated in the collection-and-separation chamber 21 and discharged through the first connector 22 is then discarded. Alternatively, it is returned to the filling system or to filling-material tank 4, 4a, but only after having been treated.

The second connector 23 connects to a gas space that is formed above the surface of the liquid filling-material in the tank 4, 4a. As a result return gas that is separated from the filling material in the collection-and-separation chamber 21 can return to this gas space through the second connector 23.

The resulting gas cushion that is present above the filling material in the filling-material tank 4, 4a is static and devoid or essentially devoid of any flow. Since it is not exchanged during filling, any alcohol vapor or aromatic compounds in the vapor state will remain and not be lost.

The inventive filling systems also facilitate an inert gas covering with minimal gas consumption. Inert gas is fed into that part of filling material tank 4, 4a that is not occupied by the filling material. Meanwhile, the collection-and-separation chamber 21 receives any surplus inert gas.

The invention has been described hereinbefore by reference to one embodiment. It goes without saying that numerous variations and modifications are possible.

1-19. (canceled)

20. A method comprising filling a container with a liquid filling-material, said method comprising selecting said liquid filling-material from the group consisting of a spirit and a wine, selecting a machine element from the group consisting of a rotor and a conveying device, providing said liquid filling-material in a tank that is connected to each of a plurality of filling elements disposed at said machine element, each of said filling elements comprising a liquid valve that, when opened, causes said filling element to dispense liquid filling-material, at a plant that is common to all of said filling elements, and that has a plurality of sealing positions, placing a container in sealing position against a plant at a first filling element, said first filling element comprising a first liquid valve, controlling flow of said liquid filling-material from said tank through said first liquid valve and into said container, closing said liquid valve, and while said liquid valve is closed, enlarging a head space of said container, wherein enlarging said head space comprises driving surplus fluid out of said container, said surplus fluid comprising surplus liquid filling-material and gas, wherein driving surplus fluid out of said container comprises selecting a pressurized Trinox gas from the group consisting of pressurized carbon dioxide gas and pressurized nitrogen gas, providing said pressurized Trinox gas through a Trinox gas path that opens into a head space of said container while said container is still sealed against said plant, and using said pressurized Trinox gas, displacing said surplus fluid out of said container, wherein providing said pressurized Trinox gas comprises passing said pressurized Trinox gas through a bellows that extends between said plant and a structure selected from said group consisting of a filling-element housing and said machine element.

21. The method of claim 20, wherein providing a pressurized Trinox gas through a gas path further comprises passing said Trinox gas through an annular channel between said bellows and a filling tube.

22. The method of claim 20, further comprising setting a filling level of said container, wherein setting said filling level comprises adjusting a height of said plant.

23. The method of claim 20, further comprising receiving said surplus fluid that has been displaced from said container into a gas space of a collection-and-separation chamber that is common to all of said filling elements, and, within said collection-and-separation chamber, causing a liquid fraction of said surplus fluid to enter a separate liquid space of said collection-and-separation chamber.

24. The method of claim 23, further comprising causing a gas fraction of said surplus fluid to be returned to said gas space, said gas space being formed above said surface of said liquid fraction in said liquid space of said tank.

25. The method of claim 23, further comprising discarding said liquid fraction from said collection-and-separation chamber.

26. The method of claim 23, further comprising using said liquid fraction to fill another container.

27. The method of claim 23, wherein receiving said fluid comprises receiving said fluid through a return path that determines a filling level of said container by causing cessation of flow of liquid filling-material into said container when a rising level of said liquid filling-material in said container submerges a distal end of said return path.

28. An apparatus comprising a filling system for filling containers with liquid filling-material selected from said group consisting of spirits and wine, said filling system comprising a plant, a plurality of filling elements, and a machine element, wherein said filling elements are disposed on said machine element, wherein said machine element conveys containers, wherein said machine element is selected from the group consisting of a transport element and a rotor that is driven to rotate, wherein each of said filling elements comprises a housing, a liquid valve, a liquid channel, a discharge opening for said liquid filling-material, a Trinox valve, a Trinox gas path, and a bellows, wherein said liquid valve enables controlled opening and closing of said liquid channel, wherein said liquid channel connects to a filling-material chamber of a tank, wherein said tank is in fluid communication with all of said filling elements, wherein each filling element is associated with one of said plurality of Trinox valves, one of said gas paths, and one of said bellows, wherein, when a container is placed in sealed position at said filling element, a Trinox gas path associated with said filling element opens into a head space of said container so that flow of pressurized Trinox gas into said container drives surplus fluid out of said container, wherein each of said Trinox gas paths passes through one of said bellows, wherein flow of pressurized Trinox gas into said filling elements is individually controllable, wherein said pressurized Trinox gas is selected from the group consisting of pressurized nitrogen gas and pressurized carbon dioxide gas, and wherein said bellows extends between said plant and a structure selected from the group consisting of said machine element and said housing.

29. The apparatus of claim 28, wherein each of said filling elements comprises a filling tube, wherein said Trinox gas path comprises an annular channel between said bellows and said filling tube, and wherein said annular channel surrounds said filling tube.

30. The apparatus of claim 28, wherein said plant has an adjustable height, wherein adjustment of said height sets a filling level in said containers.

31. The apparatus of claim 28, further comprising a collection-and-separation chamber and a plurality of return gas paths, wherein each of said return gas paths is associated with a corresponding filling element, wherein said collection-and-separation chamber is common to all of said filling elements, wherein return gas paths are connected to said collection-and-separation chamber, and wherein said collection-and-separation chamber is separate from said filling-material chamber.

32. The apparatus of claim 28, wherein each of said filling elements comprises a filling tube, wherein said Trinox gas path opens out into an annular channel that surrounds said filling tube, wherein said annular channel is closed to said exterior, and wherein, in operation, said annular channel is connected to an interior of a container that is sealed against said filling element.

33. The apparatus of claim 31, wherein each filling element further comprises a return gas tube, wherein said return gas tube comprises a return-gas-tube channel, and wherein said return-gas-tube channel connects to said collection-and-separation chamber.

34. The apparatus of claim 33, wherein each filling element further comprises a pneumatic actuation element and a first spring, wherein said liquid valve comprises a valve body and a valve stem for said valve body, wherein movement of said valve stem along an axis of said filling element opens and closes said liquid valve, wherein said return gas tube forms said valve stem, wherein, in operation, said pneumatic actuation element moves said valve stem along said axis of said filling element, and wherein said pneumatic actuation element moves said valve stem against a force exerted by said first spring.

35. The apparatus of claim 34, wherein said pneumatic actuation element comprises a control chamber, a tubular piston rod that defines a piston-rod channel, and a piston, wherein said piston delimits said control chamber, wherein said first spring pre-tensions said return gas tube, wherein said first spring pre-tensions said liquid valve into a closed position, wherein said tubular piston rod forms part of said return gas path, wherein, in operation, in response to application of a control pressure to said control chamber, said piston rod lies with an end thereof against an end of said return gas tube that is furthest from said discharge opening such that said return-gas-tube channel opens out into said piston-rod channel.

36. The apparatus of claim 35, wherein each filling element further comprises a second spring, wherein said second spring pre-tensions said piston and said piston rod in a direction for breaking a connection between said return-gas-tube channel and said piston-rod channel.

37. The apparatus of claim 34, wherein each filling element further comprises a control valve, wherein, during operation of said filling element, said control valve causes application, to said control chamber, of a pressure selected from the group consisting of a first control pressure, a second control pressure, and a third control pressure, wherein said second control pressure is less than said first control pressure, wherein said third control pressure is less than said second control pressure, wherein said first control pressure opens said liquid valve, wherein said second control pressure closes said liquid valve, and wherein said third control pressure breaks a connection between said piston-rod channel and said return-gas-tube channel.

38. The apparatus of claim 33, wherein each of said filling elements further comprises a filling-element chamber, wherein said return-gas-tube channel opens out into said filling-element chamber, wherein said filling-element chamber connects to said collection-and-separation chamber.

39. The apparatus of claim 38, wherein said filling-element chamber connects directly to said collection-and-separation chamber.

40. The apparatus of claim 38, wherein each of said filling elements further comprises a pneumatically operated valve, wherein said pneumatically operated valve connects said filling-element chamber to said collection-and-separation chamber

41. The apparatus of claim 31, wherein said collection-and-separation chamber comprises a gas-removal connector for removing gaseous constituents of said surplus fluid and a liquid-removal connector for removing liquid filling-material from said surplus fluid.
